(19) United States
(12) Patent Application Publication
(10) Pub. No.: US 2011/0001902 A1
(43) Pub. Date: Jan. 6, 2011

(54) GLASS SUBSTRATE FOR DISPLAY DEVICE, LIQUID CRYSTAL DISPLAY PANEL, AND LIQUID CRYSTAL DISPLAY DEVICE

(75) Inventors: Masahiro Ikadai, Tokyo (JP); Koji Fujita, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: Nippon Sheet Glass Company, Limited

(21) Appl. No.: 12/919,964

(22) PCT Filed: Jan. 26, 2009
(86) PCT No.: PCT/JP2009/051673

§ 371 Date: Aug. 27, 2010

(30) Foreign Application Priority Data
Feb. 29, 2008 (JP) 2008-049612

(51) Int. Cl. G02F 1/1333; B32B 3/28

(52) U.S. Cl. 349/91; 428/179

(57) ABSTRACT

There is provided a glass substrate for a display device, a liquid crystal display panel, and a liquid crystal display device capable of eliminating the display unevenness of a display panel having undergone the cell assembly and eliminating the need for a post-process or simplifying the post-process. A liquid crystal panel 30 includes two pieces of glass 10 and 32 opposed to each other; a liquid crystal layer 34 injected between the two plates of the glass 10 and 32; and spherical spacers 33a and 33b arranged so as to abut on the respective surfaces of the two pieces of glass 10 and 32. The glass 10 is 1.1 mm in thickness, wherein if a period D of a filtered waviness curve over a spatial frequency range of 2 to 500 lines/mm based on spectral analysis is greater than 20 mm under the measurement condition of a cut-off value of 0.8 to 8 mm, then an amplitude A of the filtered waviness curve is 2 μm or less, and the amplitude A, when the period D is 20 mm or less, is 18 nm or greater.

### TECHNICAL FIELD

The present invention relates to a glass substrate for a display device, a liquid crystal display panel, and a liquid crystal display device.

### BACKGROUND ART

As a substrate for a common liquid crystal display device, a 3 to 5 mm-thick float glass plate is used. This float glass plate has undulations in a direction perpendicular to the flow direction of float. These undulations are continuous in the flow direction of float. That is, a streak-like pattern is formed in the float glass plate in a direction parallel to the flow direction of float. These undulations affect the optical uniformity of surface reflection, thus if the glass substrate is assembled into a liquid crystal panel (hereinafter referred to as “the cell assembly”) in cases where a multitude of such undulations are formed, there may arise display unevenness.

As methods for removing such undulations to eliminate the above-described display unevenness, there are known a related art in which at least one of the surfaces of the glass substrate is polished so that predetermined surface roughness (0.05 μm or smaller under the measurement condition of a cut-off value of 0.8 mm to 8 mm) is reached (see, for example, Japanese Laid-Open Patent Publication (Kokai) No. 2001-235798); a related art in which a surface of the glass substrate is planarized by heat treatment (see, for example, Japanese Laid-Open Patent Publication (Kokai) No. 11-199255); and a related art in which a surface of the glass substrate is planarized by performing coating thereon (see, for example, Japanese Laid-Open Patent Publication (Kokai) No. 2005-263593).

On the other hand, the above-described undulations are known to be corrected due to the surface tension of liquid crystal when the cell assembly is performed. Accordingly, the above-described display unevenness is known to be not observed if the cell assembly is performed using a glass substrate whose plate thickness is, for example, 0.2 to 1.1 mm (±0.1) mm and whose period, when the above-described undulations are approximated by a sine curve, is at least 3.0×10⁻² m (see, for example, the pamphlet of Japanese Laid-Open Patent Publication (Kokai) No. 2008/001954).

Unfortunately, however, all of the above-described related arts involve performing a post-process, such as polishing, after the manufacture of a raw plate, in order to eliminate the display unevenness discussed above, thus resulting in cost rise.

In addition, the degree to which the above-described correction by the surface tension of liquid crystal is made becomes lower as the period of microscopic wave-like irregularities decreases. Thus, display unevenness is more likely to be observed after the cell assembly is performed. Consequently, display unevenness arising from such short-period irregularities cannot be eliminated by the methods of the related arts.

An object of the present invention is to provide a glass substrate for a display device, a liquid crystal display panel, and a liquid crystal display device capable of eliminating the display unevenness of a display panel having undergone the cell assembly and eliminating the need for a post-process or simplifying the post-process.

### DISCLOSURE OF THE INVENTION

To attain the above object, in a first aspect of the present invention, there is provided a glass substrate, having t mm in thickness, for a display device, fabricated by applying tensile stress to plate-like molten glass in two directions in plane with a surface of the molten glass and perpendicular to each other, wherein if a period D of a filtered waviness curve over a spatial frequency range of 2 to 500 lines/mm based on spectral analysis is greater than 20 mm under the measurement condition of a cut-off value of 0.8 to 8 mm, then an amplitude A of the filtered waviness curve is 2×(1.1/t)³ μm or less, and the amplitude A, when the period D is 20 mm or less and t is 1.1 mm, is 18 nm or greater.

Consequently, in at mm-thick glass substrate for a display device fabricated by applying tensile stress to plate-like molten glass in two directions in plane with a surface of the molten glass and perpendicular to each other, if, when a period D of a filtered waviness curve over a spatial frequency range of 2 to 500 lines/mm based on spectral analysis is greater than 20 mm under the measurement condition of a cut-off value of 0.8 to 8 mm, an amplitude A of the filtered waviness curve is 2×(1.1/t)³ μm or less, and if the amplitude A, when the period D is 20 mm or less and t is 1.1 mm, is 18 nm or greater, it is possible to suppress the amplitude, when the period is 20 mm or less, to 20 nm or less. Thus, it is possible to eliminate the display unevenness of a display panel having undergone the cell assembly, and eliminate the need for a post-process or simplify the post-process.

In the present first aspect, the amplitude A is preferably 12 nm or less when the period D is 20 mm or less.

Consequently, the amplitude A is 12 nm or less when the period D is 20 mm or less, thus it is possible to fabricate a display panel free from display unevenness by using this glass substrate, without having to perform surface polishing as a post-process.

In the present first aspect, surface polishing is preferably performed to set the amplitude, when the period is 20 mm or less, to 12 nm or less.

Consequently, surface polishing is performed to set the amplitude, when the period is 20 mm or less, to 12 nm or less, thus it is possible to fabricate a display panel free from display unevenness by using this glass substrate, even if the time period of surface polishing as a post-process is made shorter than usual.

In the present first aspect, the glass substrate for a display device is preferably manufactured by the float process.

Consequently, the glass substrate is manufactured by the float process, thus it is possible to reliably manufacture the glass substrate for a display device.

In the present first aspect, the glass substrate for a display device is preferably a glass substrate for liquid crystal display.

In order to achieve the aforementioned object, there is provided, according to a second aspect of the present invention, a liquid crystal display panel which uses the glass substrate for a display device.

In order to achieve the aforementioned object, there is provided, according to a third aspect of the present invention, a liquid crystal display device which uses the glass substrate for a display device.

### BRIEF DESCRIPTION OF THE DRAWINGS

FIG. 1 is a view used to explain a continuous formation method of a glass substrate for a display device according to a first embodiment of the present invention.

FIG. 2 is a cross-sectional view schematically showing a configuration of a liquid crystal panel having undergone the cell assembly using the glass of FIG. 1.

FIG. 3 is a view schematically showing a dynamical model when a portion of glass between adjacent spacers is assumed to be a beam.

FIGS. 4A and 4B are graphical views showing the measurement results of embodiment 1, wherein FIG. 4A is the result of thickness difference measurement in embodiment 1 and FIG. 4B is the result of frequency analysis in embodiment 1.

FIGS. 5A and 5B are graphical views showing the measurement results of comparative example 1, wherein FIG. 5A is the result of thickness difference measurement in comparative example 1 and FIG. 5B is the result of frequency analysis in comparative example 1.

FIGS. 6A and 6B are graphical views showing the measurement results of embodiment 2, wherein FIG. 6A is the result of thickness difference measurement in embodiment 2 and FIG. 6B is the result of frequency analysis in embodiment 2.

### BEST MODE FOR CARRYING OUT THE INVENTION

The present inventors have made intensive studies in order to achieve the above-mentioned object, and as a result, they have found that in at mm-thick glass substrate for a display device fabricated by applying tensile stress to plate-like glass having an equilibrium thickness in two directions in plane with a surface of the glass and perpendicular to each other, if, when a period D of a filtered waviness curve over a spatial frequency range of 2 to 500 lines/mm based on spectral analysis is greater than 20 mm under the measurement condition of a cut-off value of 0.8 to 8 mm, an amplitude A of the filtered waviness curve is 2×(1.1/t)³ μm or less, and if the amplitude A, when the period D is 20 mm or less and t is 1.1 mm, is 18 nm or greater, it is possible to eliminate the display unevenness of a liquid crystal panel after the glass substrate is assembled thereinto (hereinafter referred to as “the cell assembly”), and eliminate the need for a post-process or simplify the post-process.

The present invention has been made based on the above-described knowledge.

Hereinafter, embodiments of the present invention will be described using the accompanying drawings.

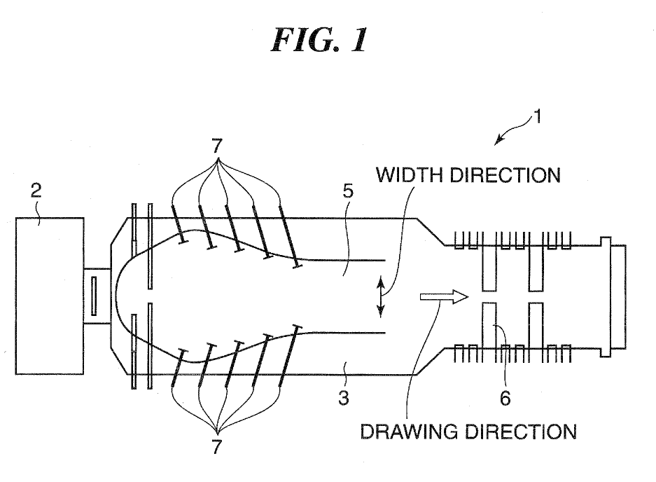

FIG. 1 is a view used to explain a continuous formation method of a glass substrate for a display device according to an embodiment of the present invention.

The glass substrate for a display device according to an embodiment of the present invention is fabricated using the float process, among continuous formation methods in which glass is formed into a plate-like shape and is then gradually thinned by applying tensile stress. It should be noted that in the present embodiment, glass 10 is fabricated using the float process. The embodiment is not limited to this method, however. Alternatively, any other method, such as the down-draw process, may be used as long as the method is one for fabricating a thin plate glass by means of continuous formation.

As shown in FIG. 1, an apparatus 1 for forming a glass 10, which is a glass substrate for a display device according to an embodiment of the present invention, includes: a tin bath 3 on which a molten glass 5 flowed in from a furnace 2 floats in a plate-like shape; conveying rolls 6 for forming the glass 10 with 1.1-mm thickness and conveying it by drawing the molten glass 5 on the tin bath 3 in a drawing direction; a plurality of gear-like top rollers 7 for catching edges of the molten glass 5 on the tin bath 3.

Under the condition of no tensile stress being applied, the molten glass 5 flowed from the furnace 2 into the tin bath 3 is set to a thickness of 6 to 7 mm, which is an equilibrium thickness, and spreads over the tin bath 3. In addition, the molten glass 5 is formed into a thin plate by pulling the leading end of the molten glass 5 spreading over the tin bath 3 by the conveying rolls 6 in a drawing direction. The thickness of the molten glass 5 formed into a thin plate by such a method as described above decreases as the rotational speed of the conveying rolls 6 is increased and thus tensile stress applied to the molten glass 5 in the drawing direction is increased.

For reasons of the properties of continuous glass formation, however, tensile stress is applied to the molten glass 5 by the conveying rolls 6 in the drawing direction with the furnace 2 in a semifixed state. If, at this time, tensile stress is not applied also in the width direction of the molten glass 5, i.e., in a direction in plane with a surface of the molten glass 5 and perpendicular to the drawing direction, bending streaks parallel to the drawing direction arise as drawing deformation in the glass 10 thus obtained, as if such deformation occurs when a resin film or rubber elongates. If a view is taken of a cross section of the glass 10 in the width direction, this deformation is observed as wave-like undulations uniform in thickness. On the other hand, if sufficient tensile stress is also applied in the width direction of the molten glass 5 by catching edges of the molten glass 5 with the top rollers 11, it is possible to eliminate the above-described wave-like undulations arising in the glass 10. In this case, however, portions of the obtained glass 10 fragile in strength undergo creep deformation, and portions thereof robust in strength undergo elastic deformation. As a result, irregularities accompanied by microscopic thickness differences arise in the glass 10 in place of the above-described wave-like undulations.

In general, spectral analysis of a filtered waviness curve performed on a continuously-formed glass under the measurement condition of a cut-off value of 0.8 to 8 mm shows that a period D based on the above-described wave-like undulations, among periods D over a spatial frequency range of 2 to 500 lines/mm, is 20 mm at the most and a few millimeters or so on average. On the other hand, a period D, among the periods D based on the above-described irregularities accompanied by microscopic thickness differences, is greater than 20 mm. It should be noted that the cut-off value is specified by JIS B 0601 and the filtered waviness curve is specified by JIS B 0651.

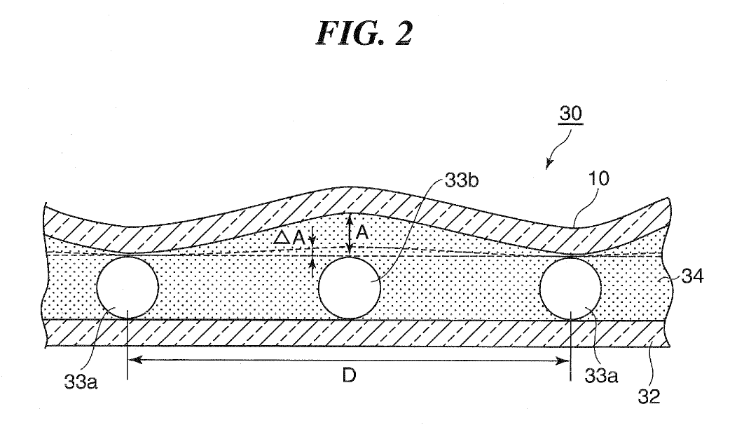

FIG. 2 is a cross-sectional view schematically showing a configuration of a liquid crystal panel having undergone the cell assembly using the glass of FIG. 1. Here, the liquid crystal panel according to the present embodiment is based on the TFT method.

In FIG. 2, a liquid crystal panel 30 includes two pieces of glass 10 and 32 opposed to each other; a liquid crystal layer 34 injected between the two pieces of glass 10 and 32; and spherical spacers 33a and 33b arranged so as to abut on the respective surfaces of the two pieces of glass 10 and 32.

In this liquid crystal panel 30, the above-described wave-like undulations have arisen in the glass 10 due to the manufacturing process (the float process) of the glass 10. This means that there exist the spacers 33a abutting on the glass 10 and the spacer 33b not abutting thereon.

That is, a difference in elevation between peaks and troughs of these wave-like undulations corresponds to the aforementioned amplitude A, and a length of one period from a certain trough to an adjacent trough corresponds to the aforementioned period D. If the two spacers 33a abut on troughs at both ends of the period D, the spacer 33b arranged at a peak existing between the troughs at the both ends is located in a position as much as the amplitude A away from the glass 10.

In practice, however, since the liquid crystal layer 34 has been injected between the two pieces of glass 10 and 32 and has surface tension, the glass 10 is attracted toward the liquid crystal layer 34 by the surface tension. Consequently, it is assumed that the amplitude A is corrected, so that a distance between the spacer 33b and the glass 10 changes to AA, as a matter of fact.

Hence, the present inventors applied the following dynamical model to the above-described phenomenon, assuming that a portion of the glass 10 between the adjacent spacers 33a is a beam.

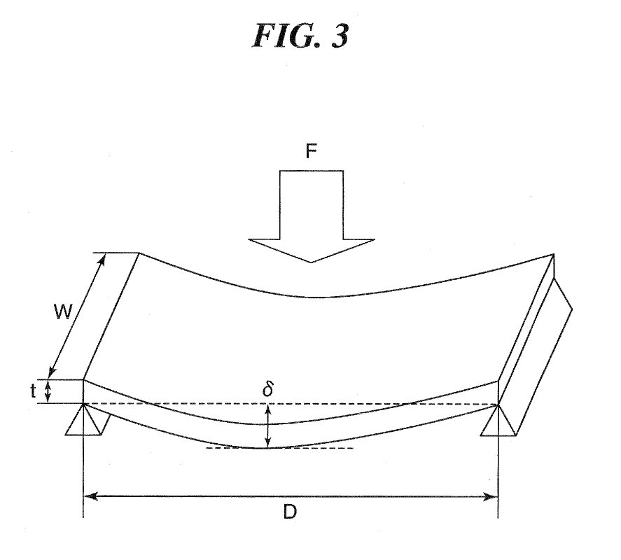

FIG. 3 is a view schematically showing a dynamical model when a portion of the glass 10 between the adjacent spacers 33a is assumed to be a beam.

In FIG. 3, the beam having a width of W and a plate thickness of t is supported by triangular columns, so as to have a beam length of D. In this case, if a load F is applied perpendicularly from above the beam, the beam sags as much as δ. At this time, the cross-sectional secondary moment I of the beam is represented by equation (1) shown below:

I=t³×W/12 (1)

In addition, flexure δ, if the cross-sectional secondary moment I is used, is represented by equation (2) shown below:

δ=F×D³/(48×E×I) (2)

(where, E is Young's modulus)

From equations (1) and (2), the flexure δ is represented by equation (3) shown below:

δ=F×D³/(4×E×W×t³) (3)

If the dynamical model of FIG. 3 is applied to the liquid crystal panel of FIG. 2, the load F in FIG. 3 corresponds to the surface tension in FIG. 2. Here, if the amount of attraction (flexure δ) of the glass 10 by the surface tension is greater than the amplitude A, the wave-like undulations of the glass 10 are corrected or alleviated by the surface tension, thereby not causing the problem of display unevenness.

However, if the amplitude of a period (wavelength) of the above-described wave-like undulations is greater than 2 μm in the glass 10 formed so as to have a thickness of 1.1 mm, it is not possible to reduce the amplitude even after the cell assembly is performed. As a result, there arises not only the problem of display unevenness, but also problems with the cell assembly itself such as inability to perform bonding. In addition, as is evident from equation (3), the flexure δ is inversely proportional to the cube of the thickness t of the glass 10. Therefore, a maximum value Aₘₐₓ tolerable as the amplitude A of the period (wavelength) of wave-like undulations arising in a glass substrate for display having thickness t is represented as Aₘₐₓ≦2×(1.1/t)³ μm.

On the other hand, flexure δ is directly proportional to the cube of the period D of the glass 10. Therefore, the above-described wave-like undulations having a period D greater than 20 mm are alleviated by the cell assembly. In contrast, the above-described irregularities accompanied by microscopic thickness differences and having a period 9 less than 20 mm cannot be alleviated by the cell assembly.

From the considerations discussed above, it was estimated that it is possible to minimize the above-described irregularities accompanied by microscopic thickness differences and having a period D less than 20 mm by decreasing tensile stress in the width direction to less than usual and increasing tensile stress in the drawing direction to greater than usual at the time of continuous formation, thereby leaving wave-like undulations arising in the glass 10 and having a period D greater than 20 mm to the extent of being able to be alleviated by the cell assembly.

As the result of adjusting tensile stress in two directions, i.e., the width and draw directions, at the time of continuous formation, the present inventors have acquired the knowledge that if there is fabricated glass having a thickness of 1.1 mm and an amplitude A of 18 nm or greater over a range of periods D greater than 20 mm, the amplitude A of the formed glass 10 can be suppressed to 20 nm or less over a range of periods D of 20 mm or less.

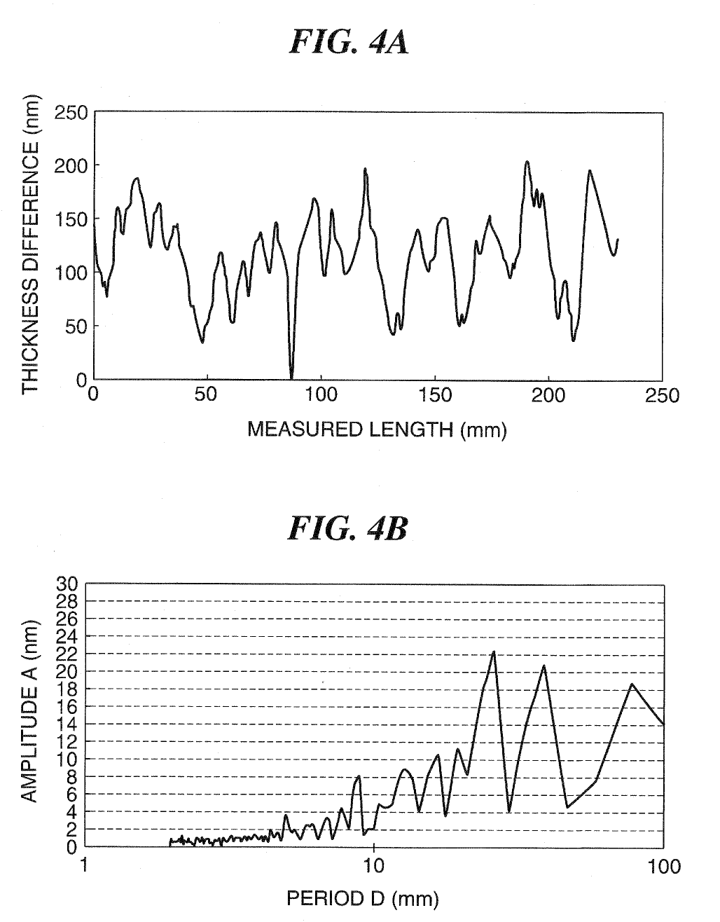

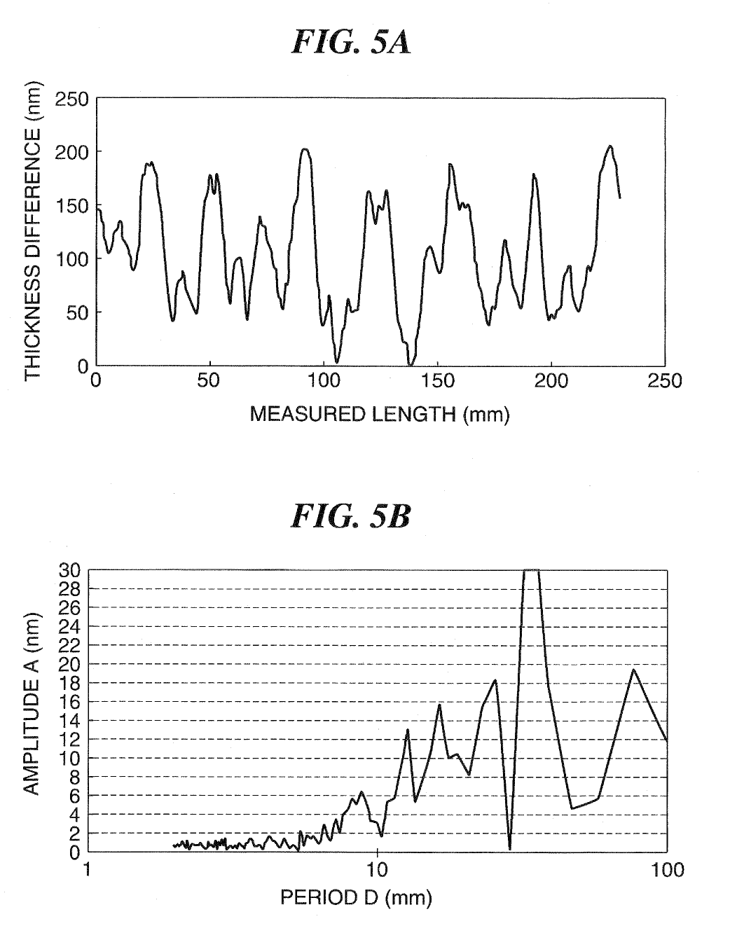

FIGS. 4A and 4B and FIGS. 5A and 5B are the results of measurement of the glass fabricated by adjusting tensile stress in the above-described two directions.

First, the thickness difference of each fabricated glass was measured under the JIS B 0601 and B 0651-compliant measurement condition of a cut-off value of 0.8 to 8 mm, as shown in FIGS. 4A and 5A.

Next, the thickness difference of each glass obtained as described above was subjected to frequency analysis (Fourier transform), as shown in FIGS. 4B and 5B. As a result, it has proved that the amplitude A of every glass is 20 nm or less over a range of periods D of 20 mm or less.

Hereinafter, glass, among the fabricated glass, whose maximum value of the amplitude A was 12 nm when the period D was 20 mm or less, as shown in FIG. 4B, is referred to as embodiment 1. On the other hand, glass, among the fabricated glass, whose maximum value of the amplitude A was 16 nm when the period D was 20 mm or less, as shown in FIG. 5B, is referred to as comparative example 1.

Thereafter, the cell assembly was performed using the glass of embodiment 1 and comparative example 1, liquid crystal panels were visually checked for display unevenness. As a result, display unevenness was not found in a liquid crystal panel subjected to the cell assembly using embodiment 1. In contrast, display unevenness was found in a liquid crystal panel subjected to the cell assembly using comparative example 1.

From the above-described results, it has proved that if the cell assembly is performed using glass, among the above-described fabricated glass, whose amplitude A over a range of periods D of 20 mm or less is 12 nm or less, it is possible to eliminate the display unevenness of the liquid crystal panel and eliminate the need for a post-process.

Next, glass, which was fabricated with usual settings without adjusting tensile stress in two directions, i.e., the width and draw directions, in such a way as described above at the time of continuous formation, was surface-polished at a polish rate of 1 μm/min, and a time taken for the amplitude A of the glass thus obtained to reach 12 nm or less over a range of periods D of 20 mm or less was measured. This measurement showed that the polishing time was three minutes. Hereinafter, the glass obtained after this surface polishing is referred to as comparative example 2.

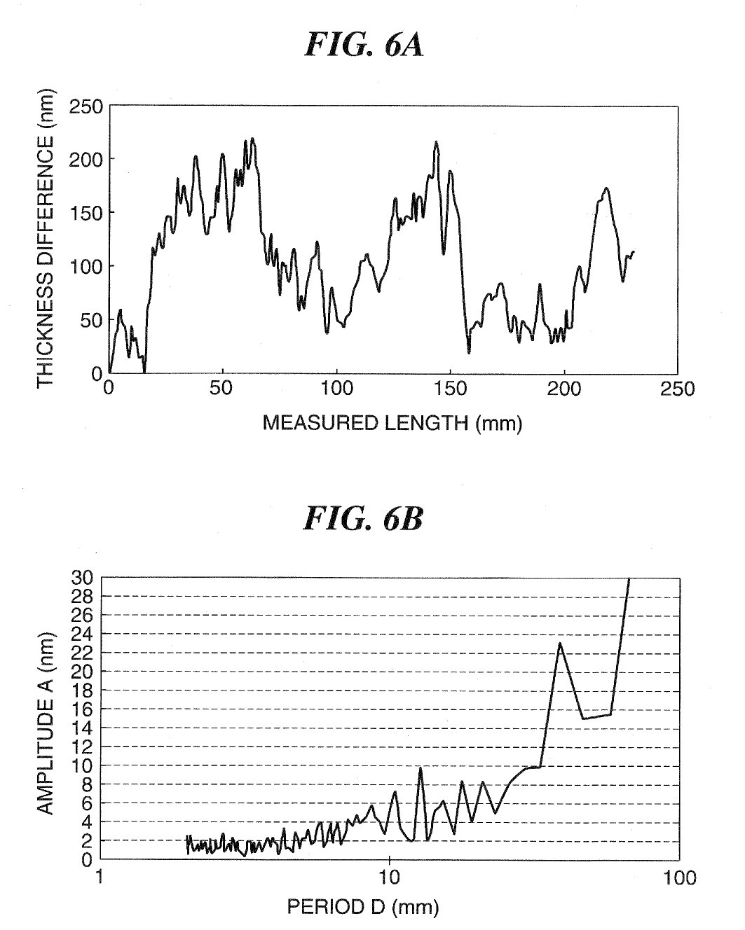

On the other hand, the above-described glass of comparative example 1 was surface-polished at a polish rate of 1 μm/min, and a time taken for the amplitude A of the glass thus obtained to reach 12 nm or less over a range of periods D of 20 mm or less was measured. This measurement showed that a polishing time taken for the glass to form into a shape represented by FIGS. 6A and 6B was one minute.

Hereinafter, the glass obtained after this surface polishing is referred to as embodiment 2.

Thereafter, the cell assembly was performed using the glass of embodiment 2 and comparative example 2, liquid crystal panels were visually checked for display unevenness. As a result, display unevenness was not found in either of liquid crystal panels subjected to the cell assembly using embodiment 2 and comparative example 2.

From the above-described results, it has proved that even in the case of glass like the one of comparative example 1, among the above-described fabricated glass, whose amplitude A over a range of periods D of 20 mm or less is greater than 12 nm, it is possible to make, shorter than usual, a time taken to polish the glass to the extent of not causing display unevenness in the liquid crystal panel after the cell assembly. The reason for this is estimated to be that the value of the amplitude A over a range of periods D of 20 mm or less in a state of embodiment 2 prior to surface polishing is smaller than that in a state of comparative example 1 prior to surface polishing.

1. A glass substrate, t mm in thickness, for a display device, fabricated by applying tensile stress to plate-like molten glass in two directions in plane with a surface of the molten glass and perpendicular to each other, wherein if a period D of a filtered waviness curve over a spatial frequency range of 2 to 500 lines/mm based on spectral analysis is greater than 20 mm under the measurement condition of a cut-off value of 0.8 to 8 mm, then an amplitude A of the filtered waviness curve is 2×(1.1/t)³ μm or less, and the amplitude A, when the period D is 20 mm or less and t is 1.1 mm, is 18 nm or greater.

2. The glass substrate for a display device according to claim 1, wherein the amplitude A is 12 nm or less when the period D is 20 mm or less.

3. The glass substrate for a display device according to claim 1, wherein surface polishing is performed to set the amplitude, when the period is 20 mm or less, to 12 nm or less.

4. The glass substrate for a display device according to claim 1, wherein the glass substrate is manufactured by the float process.

5. The glass substrate for a display device according to claim 1, wherein the glass substrate is a glass substrate for liquid crystal display.

6. A liquid crystal display panel using a glass substrate for a display device according to claim 1.

7. A liquid crystal display device using a glass substrate for a display device according to claim 1.

8. The glass substrate for a display device according to claim 2, wherein the glass substrate is manufactured by the float process.

9. The glass substrate for a display device according to claim 3, wherein the glass substrate is manufactured by the float process.

10. The glass substrate for a display device according to claim 2, wherein the glass substrate is a glass substrate for liquid crystal display.

11. The glass substrate for a display device according to claim 3, wherein the glass substrate is a glass substrate for liquid crystal display.

12. The glass substrate for a display device according to claim 4, wherein the glass substrate is a glass substrate for liquid crystal display.

13. The glass substrate for a display device according to claim 8, wherein the glass substrate is a glass substrate for liquid crystal display.

14. The glass substrate for a display device according to claim 9, wherein the glass substrate is a glass substrate for liquid crystal display.

15. A liquid crystal display panel using a glass substrate for a display device according to claim 2.

16. A liquid crystal display panel using a glass substrate for a display device according to claim 3.

17. A liquid crystal display device using a glass substrate for a display device according to claim 2.

18. A liquid crystal display device using a glass substrate for a display device according to claim 3.

19. A liquid crystal display device using a glass substrate for a display device according to claim 4.

20. A liquid crystal display device using a glass substrate for a display device according to claim 5.
